(19) United States
(12) Patent Application Publication
(10) Pub. No.: US 2012/0046825 A1
(43) Pub. Date: Feb. 23, 2012

(54) System and Method for Universal Scanner Module to Buffer and Bulk Send Vehicle Data Responsive to Network Conditions

(75) Inventors: Timothy G. Ruther, Carpentersville, IL (US); Carl Krzystofczyk, Mount Prospect, IL (US)

(73) Assignee: SNAP-ON INCORPORATED, Kenosha, WI (US)

(21) Appl. No.: 12/859,051

(22) Filed: Aug. 18, 2010

(51) Int. Cl. G06F 7/00

(52) U.S. Cl. 701/31.5

(57) ABSTRACT

Disclosed are systems and methods for retrieving and transmitting vehicle diagnostic data from a vehicle to a display device. The method includes receiving vehicle diagnostic data via a vehicle interface to a diagnostic port of a vehicle and monitoring a status of a wireless interface for transmitting the vehicle diagnostic data to a display device. Responsive to detecting a break in wireless connectivity with the display device via the wireless interface, stopping routing of the vehicle diagnostic data from the vehicle interface to the wireless interface and instead beginning routing of the vehicle diagnostic data to a local storage. An external indication of a break in connectivity may also be provided. Once wireless connectivity is restored, incoming vehicle diagnostic data may be stored in the local storage while simultaneously reading stored vehicle diagnostic data from the local storage and transmitting it via the wireless interface to the display device.

### BACKGROUND

Vehicles, such as automobiles, light-duty trucks, and heavy-duty trucks, play an important role in the lives of many people. To keep vehicles operational, some of those people rely on vehicle technicians to diagnose and repair their vehicle.

Vehicle repair technicians use a variety of tools in order to diagnose and/or repair vehicles. Those tools may include common hand tools, such as wrenches, hammers, pliers, screwdrivers and socket sets, or more vehicle-specific tools, such as cylinder hones, piston ring compressors, and vehicle brake tools.

Modern vehicles have evolved into very complex machines with thousands of various parts that perform a vast array of operations that permit the vehicle to be operated by the user. Additionally, more and more vehicle operations that previously were controlled by mechanical interactions are instead being controlled by electronic control circuits and logic. As with any such complex machine, malfunctions may occur in one or more parts of the vehicle from time to time, including the electronic control circuits.

As a result, repair technicians must now rely on sophisticated electronic equipment to diagnose and repair vehicular malfunctions. In order to ease the repair technician's access to the electronic equipment within the vehicle, modern vehicles include an on-board diagnostic port (OBD port) or a diagnostic link connector (DLC). An OBD port or DLC generally comprises a plug-in type connector that is coupled to an on-board computer within the vehicle. The on-board computer is then coupled to various sensors at various places within the vehicle. The sensors can report current operating characteristics of vehicle elements and/or sense the existence of a malfunction in the various vehicle elements. By plugging in an appropriate scanner device into the OBD or DLC, status or error codes can be retrieved from the OBD or DLC. These error codes may provide information as to the source of a malfunction in the electronic control circuits in the vehicle.

In order to further process data received from the DLC or OBD port, a diagnostic scanner device may transmit the vehicle diagnostic data to another, more robust processing device, such as a display device. The display device may further contain a database of information about the particular vehicle from which the data is retrieved, and may correlate the error codes retrieved to particular malfunctions and perhaps display further diagnostic steps that may be taken to diagnose the problem, including the retrieval of additional diagnostic data from the OBD or DLC port via the vehicle scanner device.

By providing the repair technician with detailed information for quickly diagnosing and repairing vehicles, vehicle repair times can be decreased, vehicle turn-over in creased, and as a result, repair technicians may reap increased profits from a same amount of garage space.

### OVERVIEW

Vehicle scanners tend to fall into one of two categories: large all-in-one devices that directly plug into the OBD or DLC connector and provide trouble code information and diagnostic information, or smaller single function devices that plug into the OBD or DLC connector and also plug into a more powerful display device and stream diagnostic data from the vehicle interface to the display device interface via wire-line cables or connectors.

Disclosed herein are methods and systems that provide for a compact vehicle scanner that may communicate wirelessly with a more robust separate display device. By providing for modular separation of scanner and display devices, and a wireless data connection between them, costs of the individual devices can be reduced while improving ease of use and garage clutter. In addition, and in order to compensate for potential interference and loss of wireless connectivity, several embodiments are disclosed that prevent the loss of vehicle diagnostic data due to interference and/or loss of wireless connectivity.

In accordance with a first embodiment of a vehicle scanner, a method of monitoring and processing vehicle diagnostic data includes receiving vehicle diagnostic data via a vehicle interface with a diagnostic port of a vehicle, monitoring a status of a wireless interface for transmitting the vehicle diagnostic data to one or more display devices, and responsive to detecting a break in wireless connectivity with the one or more display devices via the wireless interface, stopping routing of the vehicle diagnostic data from the vehicle interface to the wireless interface and instead beginning routing of the vehicle diagnostic data to local storage.

Furthermore, and responsive to detecting that wireless connectivity with the one or more display devices has been restored, the vehicle scanner may again begin routing the stored vehicle diagnostic data to the wireless interface for transmission to the one or more display devices. For as long as vehicle diagnostic data remains in the local storage, the vehicle scanner may continue to route the vehicle diagnostic data being received from the vehicle interface to the local storage device while simultaneously routing the stored vehicle diagnostic data to the wireless interface for transmission to the one or more display devices.

In addition to starting to buffer the vehicle diagnostic data, the vehicle scanner may, responsive to detecting the break in wireless connectivity with the one or more display devices, cause an external indication of the break in wireless connectivity. The external indication may be, for example, a lighted visual indicator disposed on an outside surface of the vehicle scanner, or may be an audio indicator, or both.

Additionally, the vehicle scanner may include one or more wire-line interfaces in addition to the wireless interface. In response to detecting an available connection to the one or more display devices via a wire-line communications interface, the vehicle scanner device may stop routing (or attempting to route) diagnostic data via the wireless interface and begin routing the diagnostic data to the wire-line interface for transmission to the one or more display devices. The wire-line communications interface may be, for example, a universal serial bus (USB) or Ethernet connection. The vehicle scanner may continue to route the vehicle diagnostic data being received from the vehicle interface to the local storage device while simultaneously routing the stored vehicle diagnostic data to the wire-line interface for transmission to the one or more display devices. The data storage within the vehicle scanner may comprise, for example, a removable memory device.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the invention.

### BRIEF DESCRIPTION OF THE DRAWINGS

Example embodiments of the invention are described herein with reference to the drawings, in which:

FIG. 1 is a block diagram of a system in which a vehicle scanner in accordance with an example embodiment may operate;

FIG. 2 is a block diagram of an example controller/display device;

FIG. 3 illustrates a view of an example controller/display device;

FIG. 4 is a block diagram of an example vehicle scanner;

FIG. 5 to FIG. 14 illustrate various views of the example vehicle scanner of FIG. 4;

FIG. 15 illustrates a process flow that the vehicle scanner may execute in accordance with an embodiment.

### DETAILED DESCRIPTION

### I. Example Architecture

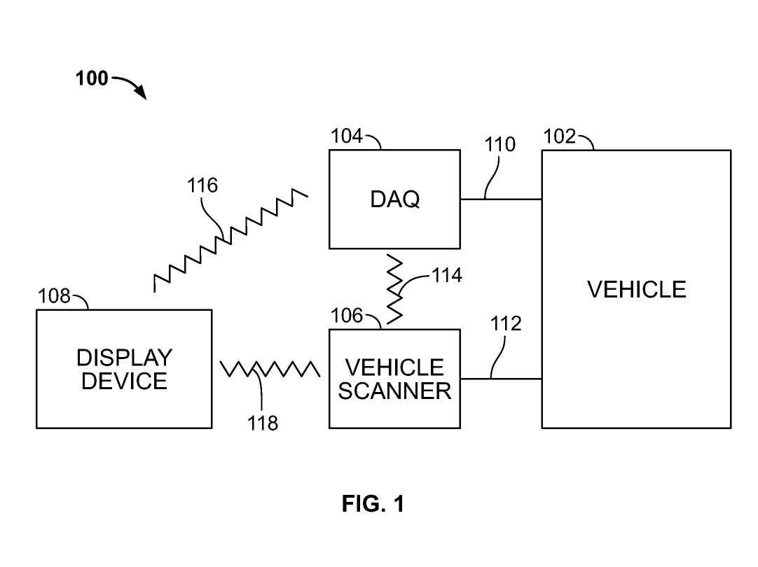

FIG. 1 is a block diagram of a system 100 in accordance with an example embodiment. System 100 comprises a vehicle 102, a data acquisition device (DAQ) 104, a vehicle scanner 106, and a controller/display device 108 (display device).

The block diagram of FIG. 1 and other block diagrams and flow charts accompanying this description are provided merely as examples and are not intended to be limiting. Many of the elements illustrated in the figures and/or described herein are functional elements that may be implemented as discrete or distributed components or in conjunction with other components, and in any suitable combination and location. Those skilled in the art will appreciate that other arrangements and elements (for example, machines, interfaces, functions, orders, and groupings of functions, etc.) can be used instead. Furthermore, various functions described as being performed by one or more elements can be carried out by a processor executing computer-readable program instructions from a computer readable medium and/or by any combination of hardware, firmware, and software.

DAQ 104 and vehicle scanner 106 may connect to a device-under-service such as vehicle 102 via wired links 112 and 114, respectively. The vehicle 102 may comprise an automobile, a motorcycle, a semi-tractor, farm machinery, or some other motorized vehicle. System 100 is operable to carry out a variety of functions, including functions for servicing device-under-service 102. The example embodiments may include or be utilized with any appropriate voltage or current source, such as a battery, an alternator, a fuel cell, and the like, providing any appropriate current and/or voltage, such as about 12 volts, about 42 volts, and the like. The example embodiments may be used with any desired system or engine. Those systems or engines may comprise items utilizing fossil fuels, such as gasoline, natural gas, propane, and the like, electricity, such as that generated by battery, magneto, fuel cell, solar cell and the like, wind and hybrids or combinations thereof. Those systems or engines may be incorporated into other systems, such as an automobile, a truck, a boat or ship, a motorcycle, a generator, an airplane and the like. DAQ 104 and vehicle scanner 106 may include batteries that provide operational power, or may receive operating power through their respective wired links 112 and 114 with the vehicle 102.

Each of the DAQ 104, vehicle scanner 106, and display device 108 may create and/or maintain a wireless link with any of the other devices via respective wireless links 114, 116, and 118. The wireless links 114, 116, and 118 may operate via a same wireless protocol, or via different wireless protocols, the only limitation being that each pair of wirelessly communicating devices in FIG. 1 must both support the particular wireless protocol.

Each of the one or more wireless links 114, 116, and 118 may be arranged to carry out communications according to an industry standard, such as an Institute of Electrical and Electronics Engineers (IEEE) 802 standard. The IEEE 802 standard may comprise an IEEE 802.11 standard for Wireless Local Area Networks (e.g., IEEE 802.11a, b, g, or n), an IEEE 802.15 standard for Wireless Personal Area Networks, an IEEE 802.15.1 standard for Wireless Personal Area Networks—Task Group 1, an IEEE 802.16 standard for Broadband Wireless Metropolitan Area Networks, an IEEE 802.15.4 standard for low-rate wireless personal area networks such as ZigBee, or some other IEEE 802 standard. For purposes of this description, a wireless network arranged according to the IEEE 802.11 standard can be referred to as a Wi-Fi network, and a wireless network arranged according to the IEEE 802.15.1 can be referred to as a Bluetooth (BT) network. Other protocols could also or alternatively be used.

Each of the devices 104, 106, and 108 may transmit data and/or commands to one another via the wireless links 114-118. As an example, display device 108 may establish a wireless link 116 DAQ 104 and send an instruction to the DAQ 104 to switch to “voltmeter mode.” DAQ 104 may then respond by taking a voltage reading from the vehicle 102 and transmitting the voltage reading to display device 108. Other instruction and data communications could also be used.

DAQ 104 may be a data acquisition device as set forth in the co-pending application titled “Method And Apparatus To Use Remote And Local Control Modes To Acquire And Visually Present Data,” Attorney Docket No. 10-254, and given U.S. application Ser. No. TBD, which is herein incorporated by reference in its entirety. Briefly, DAQ 104 may comprise a display, a wireless interface to display device 108, test leads, and logic configured to take measurements from the vehicle 102, including, for example, direct current (DC) voltage readings, alternating voltage (AC) voltage readings, and resistance readings. DAQ 104 may also provide test modes such as a diode test/continuity test mode and a capacitance test mode. An oscilloscope mode may also be provided such that a waveform is displayed on the DAQ's 104 display. DAQ 104 may include an input interface, such as a rotary switch, to choose from amongst the various measurement, test, and display modes. The DAQ 104 may also be placed into a “remote control” mode in which the display device 108 determines what measurement, test, and/or display mode the DAQ 104 is set to via commands sent to the DAQ 104 over the wireless link 116. Other features or characteristics may also be implemented.

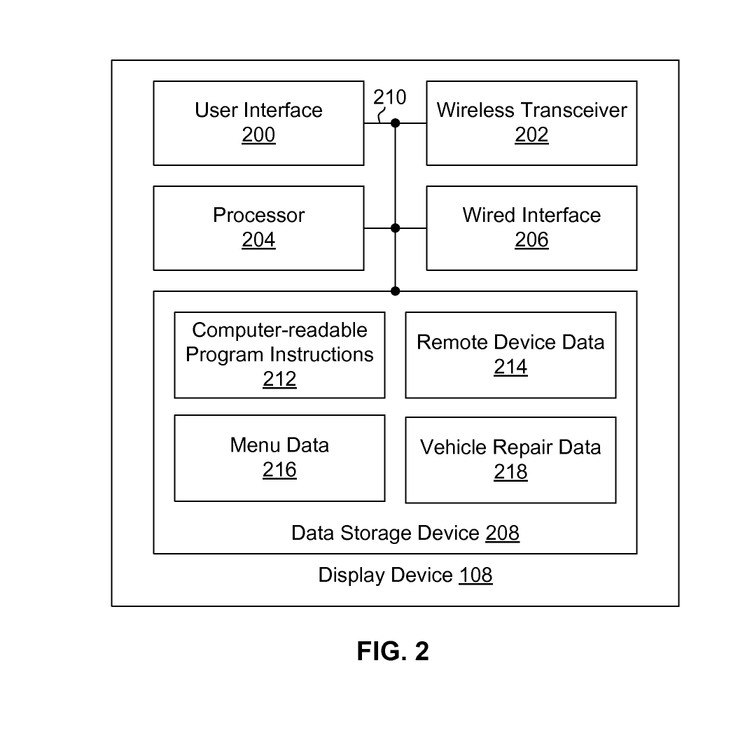

Next, FIG. 2 is a block diagram of display device 108, which includes a user interface 200, a wireless transceiver 202, a processor 204, a wired interface element 206, and a data storage device 208, all of which may be linked together via a system bus, network, or other connection mechanism 210.

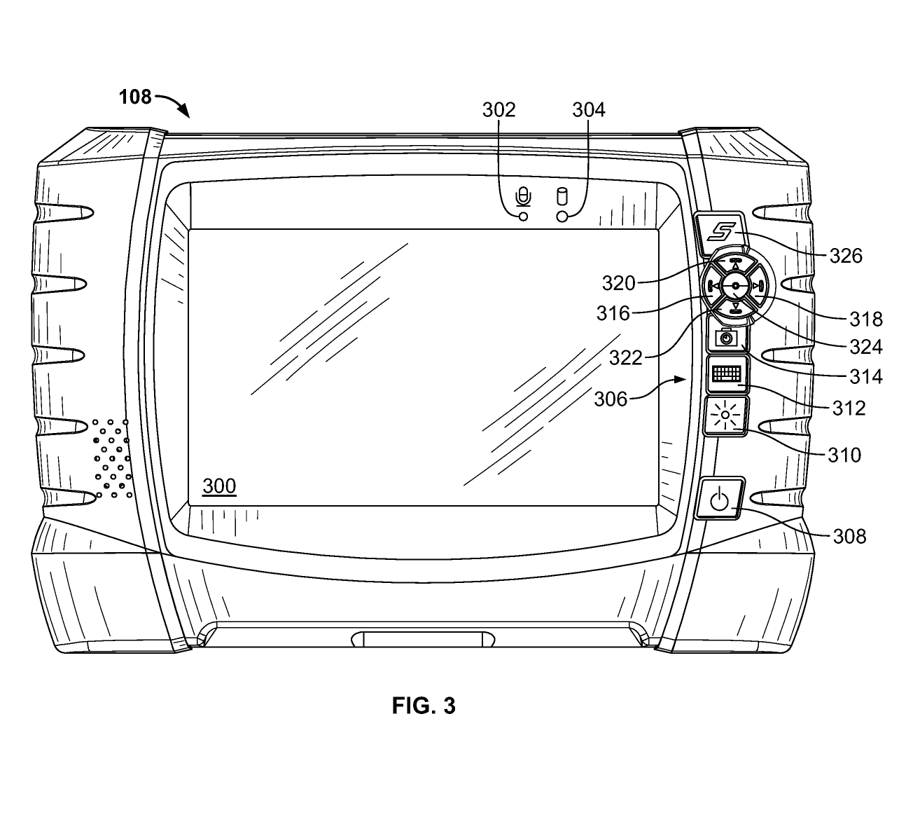

User interface 200 is operable to present data to a user and to enter user selections. User interface 200 may include a display 300 (illustrated in FIG. 3) that is operable to visually present input data transmitted to wireless transceiver 206 from a vehicle scanner 106 or DAQ 104. Display 300 may also simultaneously display input data received from multiple remote devices, such as input data received from both DAQ 104 and vehicle scanner 106. Display 300 may also display data stored at data storage device 208, such as menu data 216, or vehicle repair data 218. User interface 200 may further include an input selection element that is operable to enter a user selection. Examples of input selection elements are further illustrated in FIG. 3.

Wireless transceiver 202 comprises a wireless receiver and transmitter operable to carry out wireless communications with one or more of DAQ 104, vehicle scanner 106, and/or some other device that is operating within wireless communication range of display device 108. As an example, wireless transceiver 202 may comprise a transceiver that is operable to carry out communications via a BT network (e.g., a network that is operable to carry out communications via the IEEE 802.15.1 standard). For purposes of this description, a transceiver that is operable to carry out communications via a BT network can be referred to as a BT transceiver. As another example, wireless transceiver 202 may comprise a transceiver that is operable to carry out communications via a Wi-Fi network (e.g., a network that is operable to carry out communications via an IEEE 802.11 standard). For purposes of this description, a transceiver that is operable to carry out communications via a Wi-Fi network can be referred to as a Wi-Fi transceiver. Other wireless communications protocols could also or alternatively be used, including, for example, WiMAX, Cellular, ZigBee, Wireless USB, among others.

In accordance with an embodiment in which devices 104, 106, and 108 each include a single wireless transceiver (e.g., a BT transceiver), one of the devices, such as display device 108, may operate as a master device, and the other devices, such as DAQ 104 and vehicle scanner 106, may operate as slaves to the master. Vehicle scanner 106 and display device 108 may transmit communications via a wireless link 118 using, for example, a time-division duplex arrangement and synchronized to a clock signal of the master.

Wireless transceiver 202 is not limited to a single wireless transceiver. For example, wireless transceiver 202 may comprise a BT transceiver and a Wi-Fi transceiver. In accordance with such an example, the BT transceiver may communicate with DAQ 104 and/or vehicle scanner 106 via a BT network, and the Wi-Fi transceiver may communicate with DAQ 104 and/or vehicle scanner 106 via a Wi-Fi network.

In accordance with an embodiment in which display device 108 includes two transceivers (e.g., a BT transceiver and a Wi-Fi transceiver) and DAQ 104 and/or vehicle scanner 106 each include two transceivers (e.g., a BT transceiver and a Wi-Fi transceiver), DAQ 104 and/or vehicle scanner 106 may simultaneously transmit data to display device 108 for display via either one or both of the BT and Wi-Fi networks.

Each wireless transceiver of the example embodiments may operate in a transceiver-on-state. In the transceiver-on-state, the transceiver is powered on. While operating in the transceiver-on-state, the transceiver can transmit and receive data via an air interface. For some transceivers, while operating in the transceiver-on-state, the transceiver can transmit and receive data via the air interface simultaneously. For other transceivers, while operating in the transceiver-on-state, the transceiver can either transmit or receive data via the air interface at any given time. Each wireless transceiver of the example embodiments may also operate in a transceiver-off-state or low-power-state. While operating in the transceiver-off-state or low-power-state, the transceiver is powered off or in a low-power state and the transceiver refrains from transmitting and/or receiving data.

Wired interface 206 may include one or more wire-line ports. Each port provides an interface to display device 108 and/or to one or more circuits. In one respect, the one or more circuits may comprise electrical circuits, such as the electrical circuits of a Universal Serial Bus (USB) cable or the electrical circuits of an Ethernet cable (e.g., a CAT 5 cable). In another respect, the one or more circuits may comprise optical fibers that are operable to carry optical signals. Other examples of the one or more circuits are also possible.

Processor 204 may comprise one or more general purpose processors (e.g., INTEL microprocessors) and/or one or more special purpose processors (e.g., digital signal processors). Processor 204 may be configured to execute computer-readable program instructions 212 that are contained in computer-readable data storage device 208 and which cause the processor 204 to perform the functionality described below.

Data storage device 208 may comprise a computer-readable storage medium readable by processor 204. In the context of this document, a computer-readable medium is an electronic, magnetic, optical, or other physical device or means that can contain or store a computer program for use by, or in connection with, a computer related system or method. The methods can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. Data storage device 208 may contain various data including, but not limited to, computer-readable program instructions (CRPI) 212, remote device data 214, menu data 216, and/or vehicle repair data 218. For brevity in this description, computer-readable program instructions are sometimes referred to as program instructions.

Remote device data 214 may include data associated with a device that is arranged to communicate with display device 108 via wireless network 110. For example, remote device data 214 may include data associated with one of the DAQ 104 and vehicle scanner 106, such as a radio identifier, MAC address, security key, and/or password information. The associated data may be received at display device 108, for storing as remote device data 214, during a pairing process carried out between display device 108 and the DAQ 104 and/or vehicle scanner 106. For example, the pairing process between vehicle scanner 106 and display device 108 may include vehicle scanner 106 providing display device 108 with the data associated with vehicle scanner 106 and display device 108 providing vehicle scanner 106 with data associated with display device 108. After carrying out the pairing process, display device 108 may use the stored remote device data 214 in establishing the communication link 118 with vehicle scanner 106. Remote device data 214 is not limited to data associated with one remote device. In that regard, remote device data 214 may also include data associated with DAQ 104 and other devices not illustrated in the figures.

Menu data 216 comprises data that can be visually presented via user interface 200. Menu data 216 may include, for example, icons and images that provide a user with a graphical representation of input and functionality options. Input elements may then be used to traverse the menu data 216 displayed on the display 300.

CRPI 212 may comprise program instructions that are executable by processor 204 to perform functions represented by the program instructions, such as operating system program instructions that provide for direct control and management of hardware components such as processor 204, data storage device 208, and user interface 200. The operating system can manage execution of other program instructions within CRPI 212. As an example, the operating system may comprise the Windows XP Embedded (XPe) operating system available from Microsoft Corporation, Redmond, Wash., United States. Other examples of the operating system are also possible.

CRPI 212 may further comprise program instructions (referred to herein as PI-212-A) that are executable by processor 204 so as to cause display device 108 to operate as a peripheral manager (PM) that manages functions carried out by peripheral devices, such as DAQ 104 and vehicle scanner 106.

CRPI 212 may further comprise program instruction (referred to herein as PI-212-B) that are executable by processor 204 to cause the wireless transceiver 202 to transmit instructions or mode-selection commands to one or more of DAQ 104 and vehicle scanner 106. In one respect, the instruction mode-selection command may be addressed to a specific remote device, such as vehicle scanner 106. In another respect, the instruction or mode-selection command may be broadcast to any device within a transmission range of the wireless transceiver 202. In either respect, the instruction or mode-selection command may or may not include data that identifies the display device 108 as the source of the instruction or mode-selection command.

Next, FIG. 3 illustrates a front view of an example embodiment of display device 108 with which vehicle scanner 106 may communicate. Display device 108 includes a display 300, a status indicator 304 (e.g., a light emitting diode (LED)), and user controls 306.

Display 300 may comprise a liquid crystal display (LCD), a plasma display, an electrophoretic display, or some other type of display. Display 300 is operable to visually present (e.g., display) data to a user, including, for example, vehicle diagnostic data transmitted to the display device 108 from the vehicle scanner 106. For purposes of this description, data displayed at display device 108 is referred to as “displayed data.” The data received from the vehicle scanner 106 and presented on the display 300 may take the form of an alphanumeric presentation, a graphical presentation, or some other type of presentation.

User controls 306 are operable to enter a user selection. User controls 306 may be arranged in various ways. In that regard, user controls 306 may be arranged to include a keypad, rotary switches, push buttons, or some other means to enter a user selection. As set forth in the example embodiment illustrated in FIG. 3, user controls 306 may include, among others, a power button 308, a brightness button 310, a keyboard button 312, a cursor left button 316, a cursor right button 318, a cursor up button 320, a cursor down button 322, a menu item selection button 324, and a quick access button 326. Table 1 lists example user selections that can be entered using user controls 306. Other examples of user controls 306 and other examples of user selections are also possible.

TABLE 1

| User Button | Example User Selection |
|---|---|
| Power button 308 | Turn display device 108 power on and off. |
| Brightness button 310 | Increase or decrease a brightness of display 300. |
| Keyboard button 312 | Display keyboard at display 300. |
| Cursor left button 316 | Move a cursor, displayed at display 300, to the left. |
| Cursor right button 318 | Move a cursor, displayed at display 300, to the right. |
| Cursor up button 320 | Move a cursor, displayed at display 300, upwards. |
| Cursor down button 322 | Move a cursor, displayed at display 300, downwards. |
| Menu item selection button 324 | Select a menu item from a displayed menu data. |
| Quick access button 326 | Select a function that pertains to a current operating mode |
| | of display device 108. |

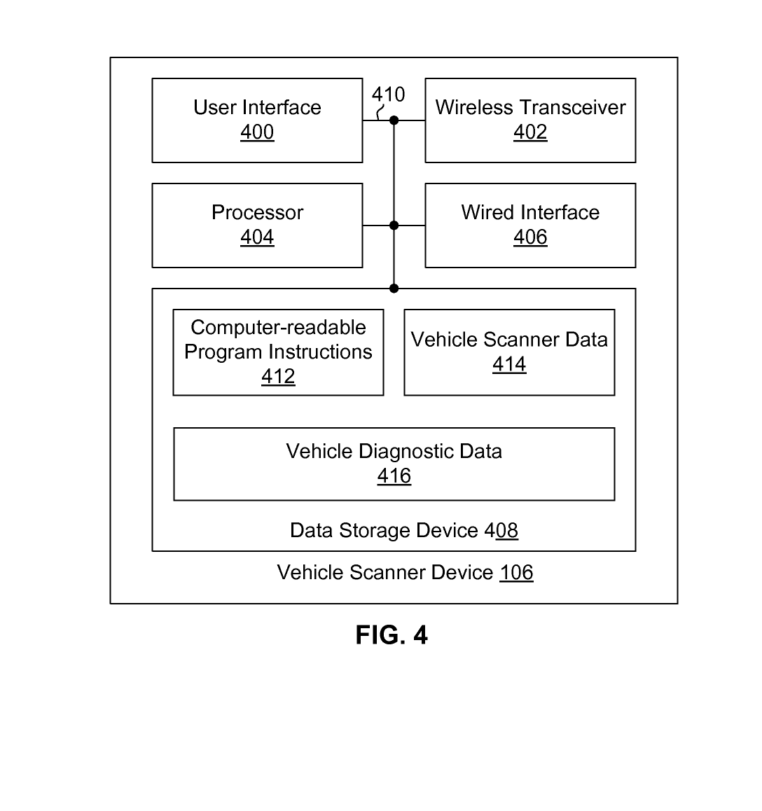

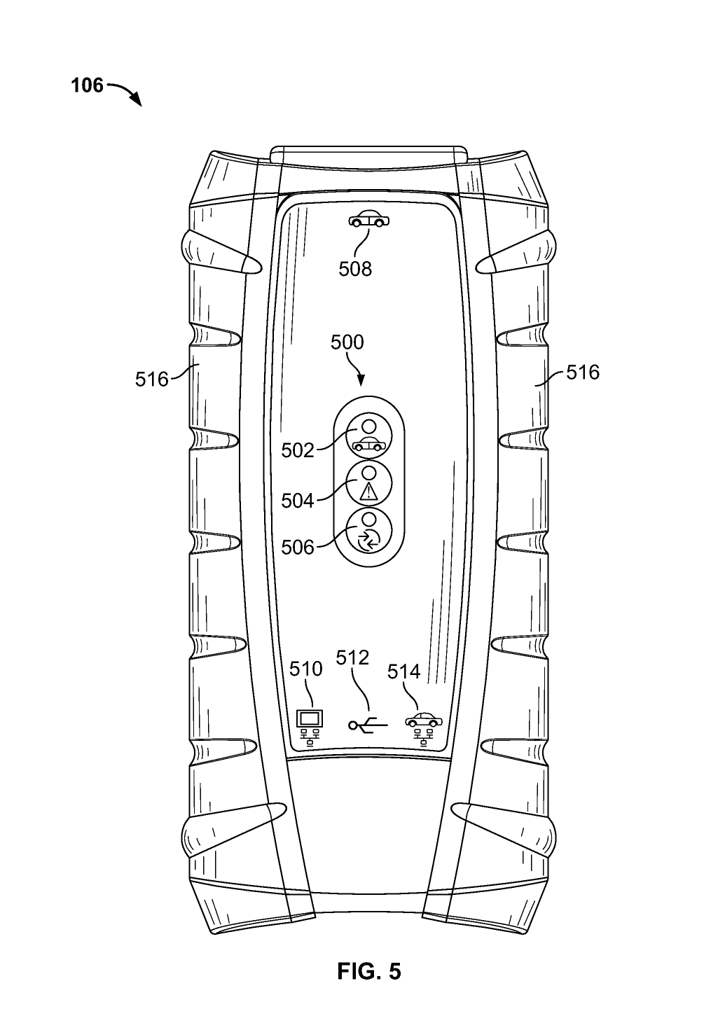

Next, FIG. 4 is a block diagram of vehicle scanner 106, and FIG. 4 to FIG. 14 illustrate various views and details of embodiments of vehicle scanner 106. As illustrated in FIG. 4, vehicle scanner 106 includes a user interface 400, a wireless transceiver 402, a processor 404, a wired interface 406, and a data storage device 408, all of which may be linked together via a system bus, network, or other connection mechanism 410. User interface 400 is operable to present information to a user of vehicle scanner 106. Elements of user interface 400 are illustrated in FIG. 5.

Wireless transceiver 402 comprises a wireless receiver and transmitter operable to carry out wireless communications with one or more of DAQ 104, display device 108, and/or some other device that is operating within wireless communication range of vehicle scanner 106. As an example, wireless transceiver 402 may comprise a transceiver that is operable to carry out communications via a BT network. As another example, wireless transceiver 402 may comprise a transceiver that is operable to carry out communications via a Wi-Fi network. Other wireless communications protocols could also or alternatively be used, including, for example, WiMAX, Cellular, ZigBee, Wireless USB, among others.

Wireless transceiver 402 is not limited to a single wireless transceiver. For example, wireless transceiver 402 may comprise both a BT transceiver and a Wi-Fi transceiver. In accordance with such an example, the BT transceiver may communicate with display device 108 and/or DAQ 104 via a BT network, and the Wi-Fi transceiver may communicate with display device 108 and/or DAQ 104 via a Wi-Fi network.

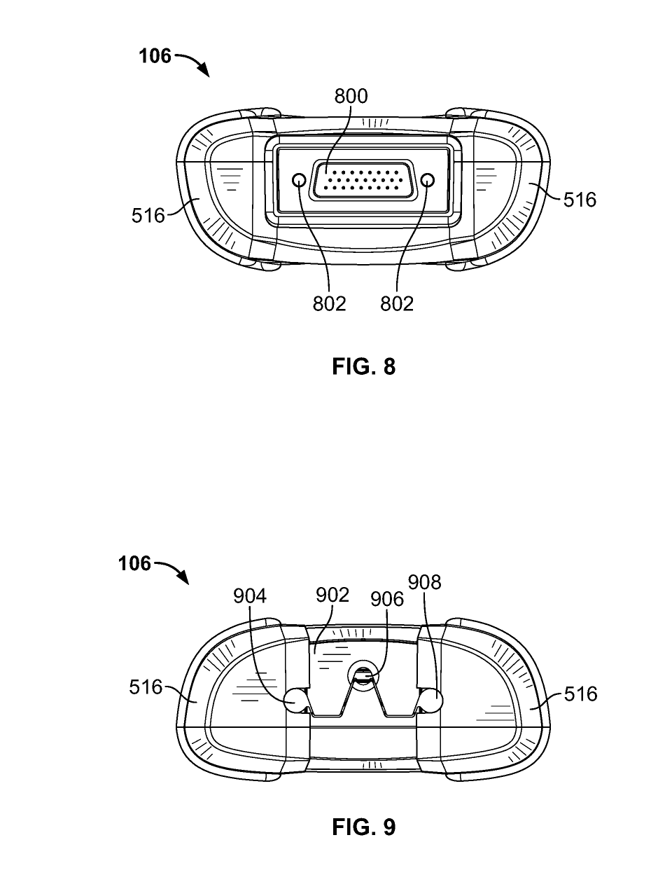

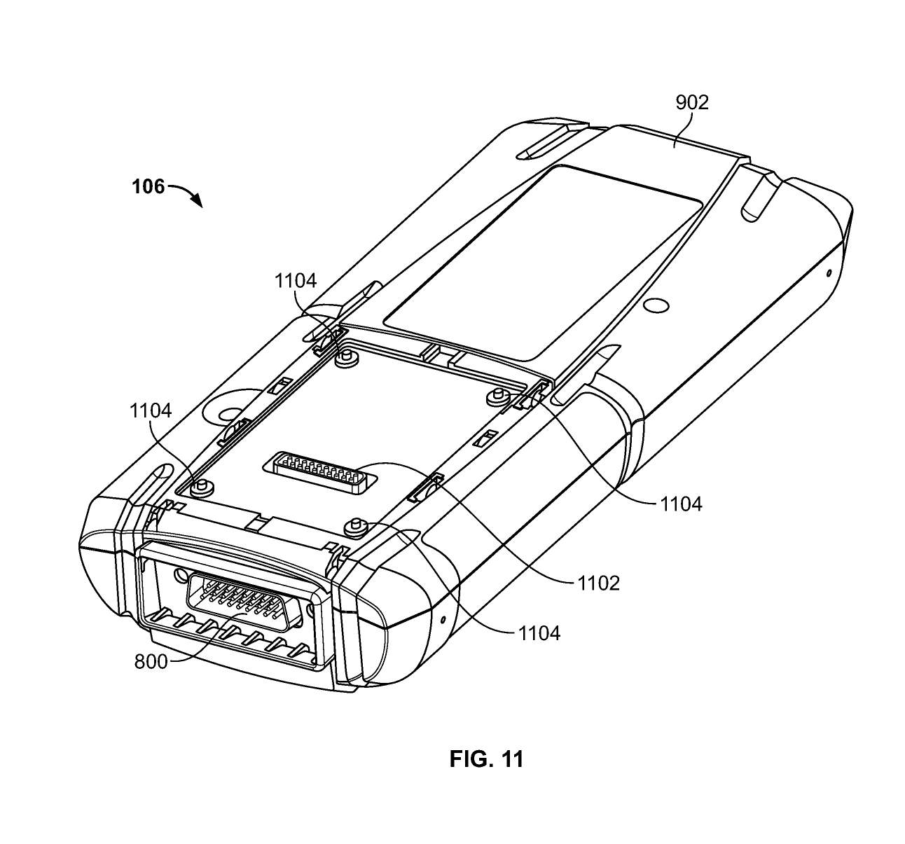

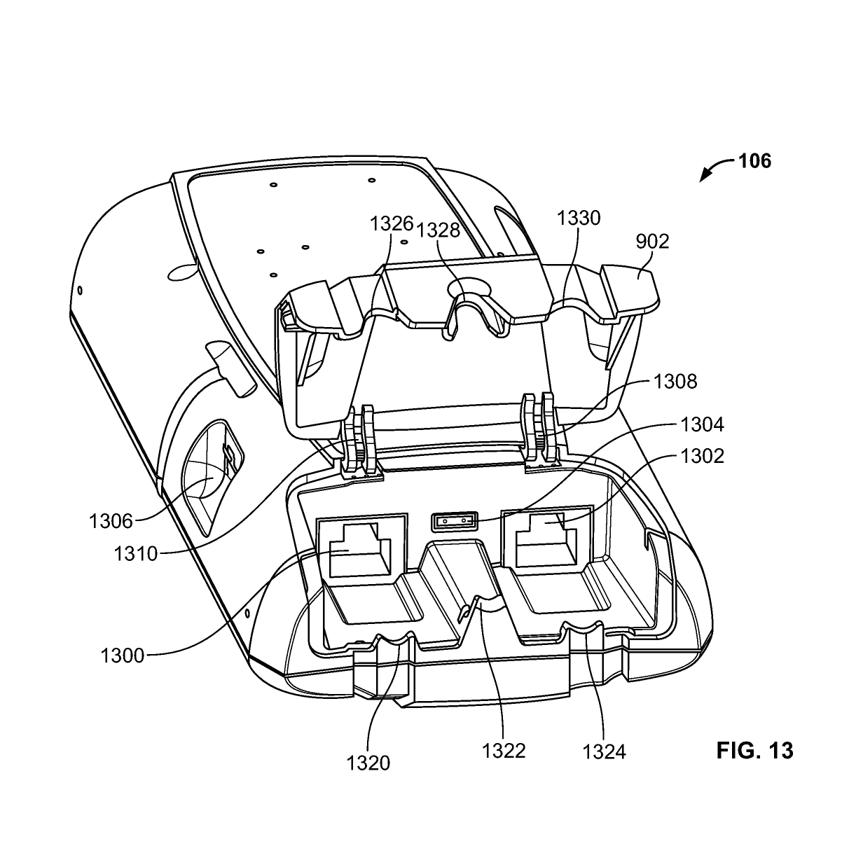

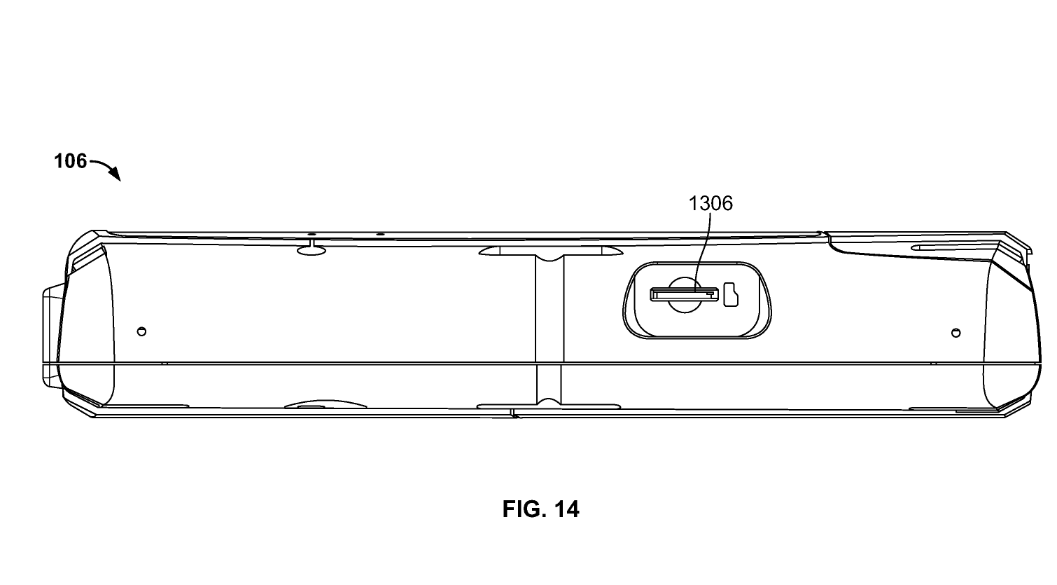

Wired interface 406 may comprise one or more wire-line ports. As an example, wired interface 406 may include wired ports 800 (illustrated in FIG. 8), 1300 and 1302, port 1304 (all illustrated in FIG. 13), slot 1306 (illustrated in FIG. 14), and port 1102 (illustrated in FIG. 11).

Port 800 may be a vehicle interface port that communicatively connects the vehicle scanner 106 to a vehicle 102 via wired link 112. In that regard, wired link 112 may comprise a vehicle interface cable having two cable ends. A first cable end of the vehicle interface cable may include a connector that is connectable to and removable from port 800. A second cable end of the vehicle interface cable may include a connector that is connectable to and removable from a connector in the vehicle 102. The connector in the vehicle 102 may be arranged according to a particular connector standard, such as Society of Automotive Engineers (SAE) specification J-1962 or some other connector standard.

Ports 1300 and 1302 may comprise respective Ethernet ports. Each Ethernet port may communicatively connect to a first end of a respective Ethernet cable. A second end of a respective Ethernet cable may connect to an Ethernet port directly or indirectly connected to local or wide area network (such as the Internet). Another respective Ethernet cable may connect the vehicle scanner 106 to the display device 108 via a corresponding Ethernet port provided on the display device 108. Ethernet ports 1300 and 1302 may additionally provide a path for upgrading internal program code within the vehicle scanner 106, such as CRPI 412.

Port 1304 may comprise a USB port. The USB port 1304 may communicatively connect to a first end of a USB cable. A second end of the USB cable may connect to a corresponding USB port provided on the display device 108. Alternatively, USB port 1304 may connect the vehicle scanner 106 to a personal digital assistant (PDA) device. In this mode, the PDA may act as a USB master and provide instructions to, and receive data from, the vehicle scanner 106. Further, in the event that a mass storage device (such as a flash memory stick) is plugged into the USB port 1304, USB port 1304 may provide data storage in addition to or in place of data storage device 408.

Slot 1306 may be a memory cart slot that allows additional storage capacity to be added to the device by insertion of a corresponding memory card, or allows propriety diagnostic programs to be loaded via memory card. Memory card slot 1306 is further illustrated in FIGS. 13 and 14.

Port 1102 may be an expansion circuit board port that allows an expansion board to be attached to the vehicle scanner 106 and provide additional functionality. This port is further illustrated in FIG. 11.

Wired interface 406 may further include a configurable set of switches and circuits in communication with port 800 in order to configure port 800 to communicate with a particular vehicle 102. More specifically, because different makes and models of vehicles utilize different signaling standards on their respective diagnostic port, wired interface 406 must include circuits and switches that allow the single port 800 to interface with a varying set of vehicle diagnostic port standards. For example, under the OBD II standard umbrella, signaling interfaces compliant with SAE J1850 PWM, SAE J1850 VPW, ISO 9141-2, ISO 14230 KWP2000, and ISO 15765 CAN could all potentially be used. Switch information may be stored locally in data storage device 408 that, in response to receiving vehicle information from display device 108, sets the switches and circuits to match the required signaling standard. Alternatively, vehicle scanner 106 may receive circuit and switch instructions via wireless transceiver 402 and/or wired interface 406, either from display device 108 or from some other device.

Processor 404 may comprise one or more general purpose processors (e.g., INTEL microprocessors) and/or one or more special purpose processors (e.g., digital signal processors). Processor 404 may be configured to execute computer-readable program instructions 412 that are contained in computer-readable data storage device 408 and which cause the processor 404 to perform the functionality described below.

Data storage device 408 may comprise a computer-readable storage medium readable by processor 404. Data storage device 408 may contain various data including, but not limited to, CRPI 412, vehicle scanner data 414, and vehicle diagnostic data 416. CRPI 412 may comprise program instructions for carrying out any one or more of the vehicle scanner 106 functions herein described. Vehicle scanner data 414 may include switch settings for configuring wired interface 406 and/or commands/data received from display device 108 for configuring wired interface 406 and/or for communicating with the vehicle 102.

Vehicle scanner data 414 may further comprise data received at vehicle scanner 106 during a pairing process carried out between vehicle scanner 106 and the DAQ 104 and/or display device 108. For example, the pairing process between vehicle scanner 106 and display device 108 may include vehicle scanner 106 providing display device 108 with the data associated with vehicle scanner 106 and display device 108 providing vehicle scanner 106 with data associated with display device 108. After carrying out the pairing process, vehicle scanner 106 may use the stored data in establishing the communication link 118 with display device 108. The pairing data is not limited to data associated with one remote device. In that regard, the pairing data may also include data associated with DAQ 104 and other devices not illustrated in the figures.

Vehicle diagnostic data 416 may comprise data received from the vehicle 102, including for example, sensor data or error code data.

Data storage device 408 may comprise permanent internal storage comprised of, for example, magnetic or semiconductor-based memory, and/or may comprise a removable memory device, such as a flash card or USB memory stick, or may comprise a combination of the above. Data storage device 408 may comprise a removable card or stick inserted into one or more of USB port 1304 and/or a memory card inserted into memory card slot 1306. Other types of storage could also be used.

Next, FIG. 5 illustrates a front view of an example embodiment of vehicle scanner 106. As forth in FIG. 5, the front face of vehicle scanner 106 includes visual indicators 502-514 and side grips 516. Visual indicators 502, 504, and 506, which may be part of user interface 400, may comprise respective light emitting diodes (LEDs) or some other visual indictor that is operable to convey information to a user. Data storage device 408 may include CRPI executable by processor 404 to turn visual indicators 502, 504, and 506 on and off to reflect a corresponding status of the vehicle scanner 106.

Visual indicator 502 may turn on to indicate that vehicle scanner 106 is receiving electrical power from vehicle 102. Because vehicle scanner 106 may not include its own power source, it may rely upon vehicle 102 to provide it with operating power via the vehicle connector. If visual indicator 502 fails to light after connecting vehicle scanner 106 to the vehicle 102, a repair technician may know to test and/or diagnose the vehicle's 102 electrical system. Absent another power source, vehicle scanner 106 may fail to operate.

Visual indicator 504 may turn on and off in a periodic manner so as to flash (e.g., turn on for 1 second and then turn off for 1 second). In particular, visual indicator 504 may flash in specific sequences so as to identify any of a variety of diagnostic or error codes. The diagnostic codes, for example, could pertain to (i) an error in the vehicle 102, (ii) an error within the vehicle scanner 106, or (iii) an error communicating with display device 108. As an example, visual indicator 502 may flash 3 times, wait, and then flash 2 more times, so as to visually present a diagnostic code of 32, which could imply that a wireless connection with display device 108 has failed.

Visual indicator 506 may turn on to indicate that vehicle scanner 106 is carrying out communications with vehicle 102. More specifically, visual indicator 506 may turn on to indicate that vehicle scanner 106 is presently carrying out communications with at least one electronic control unit (ECU) within the vehicle 102, and visual indicator 1704 may turn off to indicate that vehicle scanner 106 is not presently carrying out communications with at least one ECU within the vehicle 102.

Visual indicator 508 is an orientation indicator, providing an indicator to a repair technician of which side of the vehicle scanner 106 that the vehicle connector port 800 can be found (See FIG. 8).

Visual indicators 510 and 514 are communication port activity indicators, and provide an indication of communications activity on respective Ethernet ports 1300 and 1302 (See FIG. 13). Visual indicators 510 and 514 may flash with a periodic intensity relative to a rate of data being communicated over Ethernet ports 1300 and 1302. Visual indicator 512 is another communication port activity indicator, but instead provides an indication of communications activity on the USB port 1304 (See FIG. 13). Visual indicator 512 may light up when a USB cable is attached and properly connects vehicle scanner 106 to another active device, such as display device 108 or a PDA device. Other methods of providing visual indicators are also possible.

Although not shown, any one of the visual indicators noted above could be replaced by an audio indicator. For example, visual indicator 504 could be replaced with a speaker (or with an audio jack for connecting a device that converts electrical signals into audio signals) that emits a continuous or periodic audio tone to indicate a particular diagnostic and/or error code.

Grips 516 are arranged along the two longitudinal ends of the vehicle scanner, and may function to keep access port cover 902 (See FIGS. 9 and 13) closed and to provide shock absorption in the event that the vehicle scanner is dropped or struck. Grips 516 may be formed as a single piece of rubber connected along a rear or end of the vehicle scanner 106, or may be formed as two separate pieces of rubber. Materials other than rubber could alternatively be used. Grips 516 may have to be removed from the vehicle scanner 106 in order to open access port cover 902.

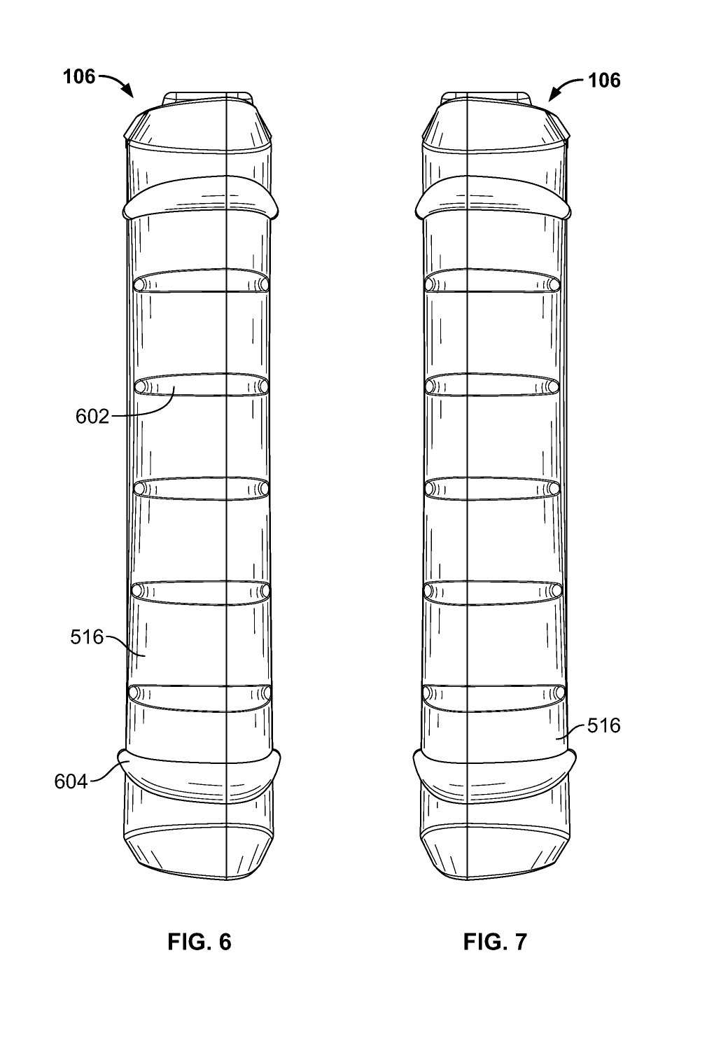

FIGS. 6 and 7 illustrate left-side and right-side views of the example embodiment of vehicle scanner 106, respectively. As shown, grips 516 may include concave ribs 602 and convex ribs 604 to improve the ease and comfort of holding the vehicle scanner 106.

Next, FIG. 8 illustrates a top view of the vehicle scanner 106. FIG. 8 further illustrates grips 516, and newly illustrates vehicle interface port 800 and connector mounting holes 802. As an example, port 800 may include a high-density-26 (HD-26) connector, but is not so limited. An HD-26 connector may include 26 male or female connector terminals. Port 800 is arranged to facilitate a wire-line connection to vehicle 102 via wired link 112. Wired link 112 may comprise a cable that includes fasteners that are arranged to fasten one end of the cable to vehicle scanner 106 via connector mounting holes 802. The other end of the cable may include similar fasteners to rigidly secure the cable to the vehicle's 102 diagnostic port.

FIG. 9 illustrates a bottom view of the vehicle scanner 106. FIG. 9 further illustrates grips 516 and newly illustrates access port cover 902 and cable openings 904, 906, and 908. Access port cover 902 covers wired-line Ethernet connectors 1300 and 1302, and USB port 1304. Cable openings 904, 906, and 908 allow respective cables connected to ports 1300-1304 to extend away from vehicle scanner 106 while allowing the access port cover 902 to remain in a closed position. While in a closed position, access port cover 902 serves as a cable support for any one or more cables extending through cable openings 904, 906, and 908.

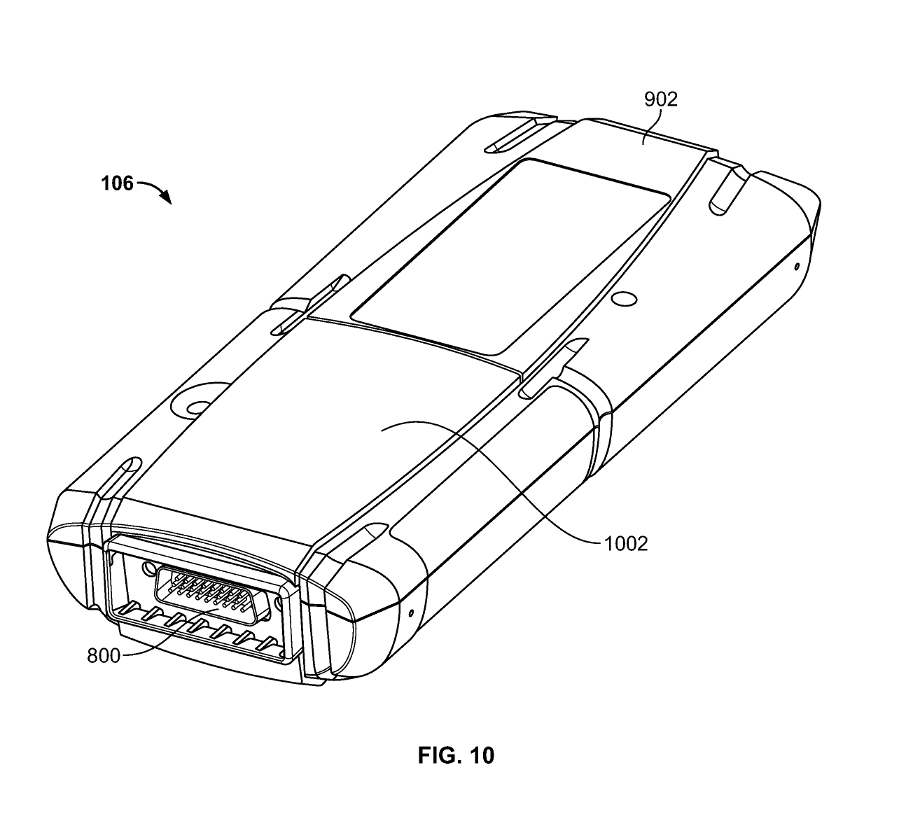

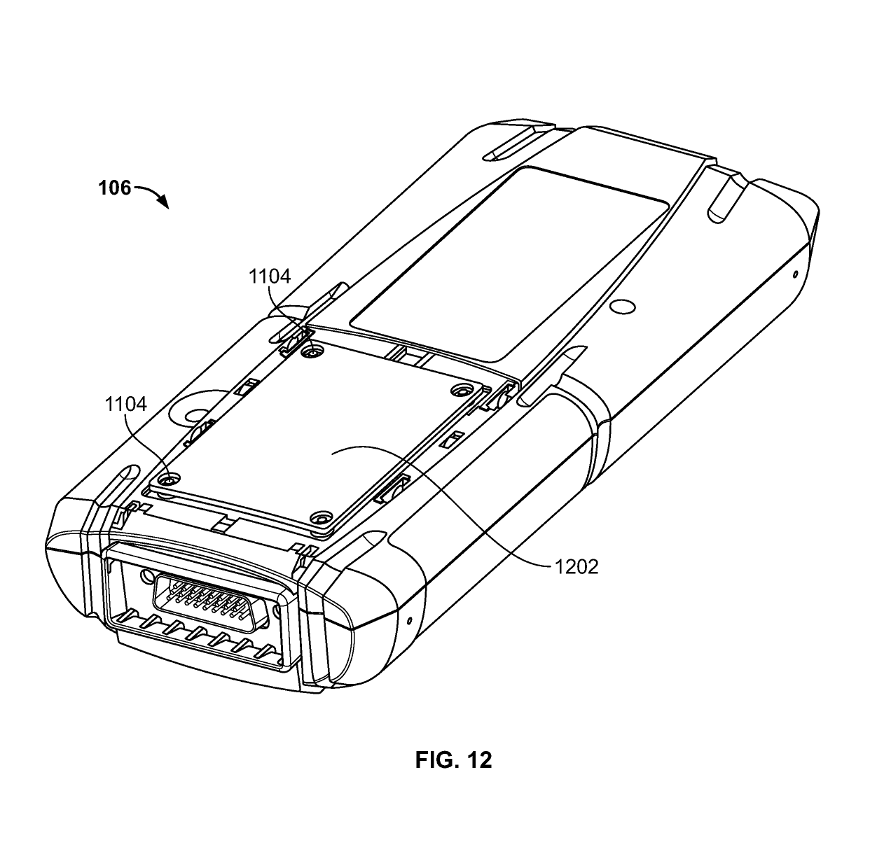

Next, FIG. 10 illustrates vehicle scanner 106 with side grips 516 removed and upper cover 1002 in a closed and secured position. FIG. 11 illustrates vehicle scanner 106 with the upper cover 1002 removed to reveal expansion port 1102 and interface lugs 1104. As shown in FIG. 12, an expansion circuit board 1202 can be secured to the expansion port 1102 and interface lugs 1104. Expansion circuit board 1202 may include a mating port (not shown) that is connectable to expansion port 1102. Expansion circuit board 1202 may comprise, for example, a printed circuit board (PCB) containing a plurality of discrete circuit elements and/or one or more integrated circuits (ICs).

Once the expansion circuit board 1202 is connected, a same or similar upper cover 1002 can then be secured over the expansion circuit board 1202 to enclose the board 1202. Various expansion circuit boards 1202 can be interfaced with vehicle scanner 106 to provide additional and/or more robust functionality without the need to manufacture an entirely new vehicle scanner 106 device.

FIG. 13 illustrates a vehicle scanner 106 with the access port cover 902 placed in an open position. As set forth in FIG. 13, access port cover 902 may be hingedly attached to the vehicle scanner 106 via hinges 1308 and 1310. Hinges 1308 and 1310 are rotatable so as to allow port access cover 902 to move from the open position to the closed position and from the closed position to the open position. Channels 1320-1324 formed in a bottom surface of the vehicle scanner 106 and channels 1326-1330 formed in the access port cover 902 form cable openings 904-908 when access port cover 902 is placed in the closed position.

As set forth earlier, while the access port cover 902 is open, access is provided to Ethernet ports 1300 and 1302, and USB port 1304. In alternative embodiments, the ports accessible via access port cover 902 may include a different quantity, or may include different types of ports, including, for example, Firewire or eSATA ports. Vehicle scanner 106 may include a respective cable opening for each port accessible via access port cover 902. Alternatively, one or more cable openings 904-908 may allow cables for more than one port to pass through port access cover 902.

FIG. 14 illustrates a side-view of vehicle scanner 106 and a detailed view of memory card slot 1306. Memory card slot 1306 may provide the data storage 408 for vehicle scanner 106, or may provide removable data storage in addition to separate data storage 408 provided permanently inside vehicle scanner 106. A data storage card for insertion in the memory card slot 1306 may include, for example, a Compact Flash card, an SD memory card, a mini SD memory card, an xD card, or other type of data storage card. Whether a data storage card inserted in memory card slot 1306 comprises the data storage 408 or an alternative data store, the data storage card may provide CRPI for execution by processor 404 of the vehicle scanner 106. The removable data storage card may also provide storage space for storage of vehicle diagnostic data 416, either in place of data storage device 408 or in addition to data storage device 408.

### II. Example Operation

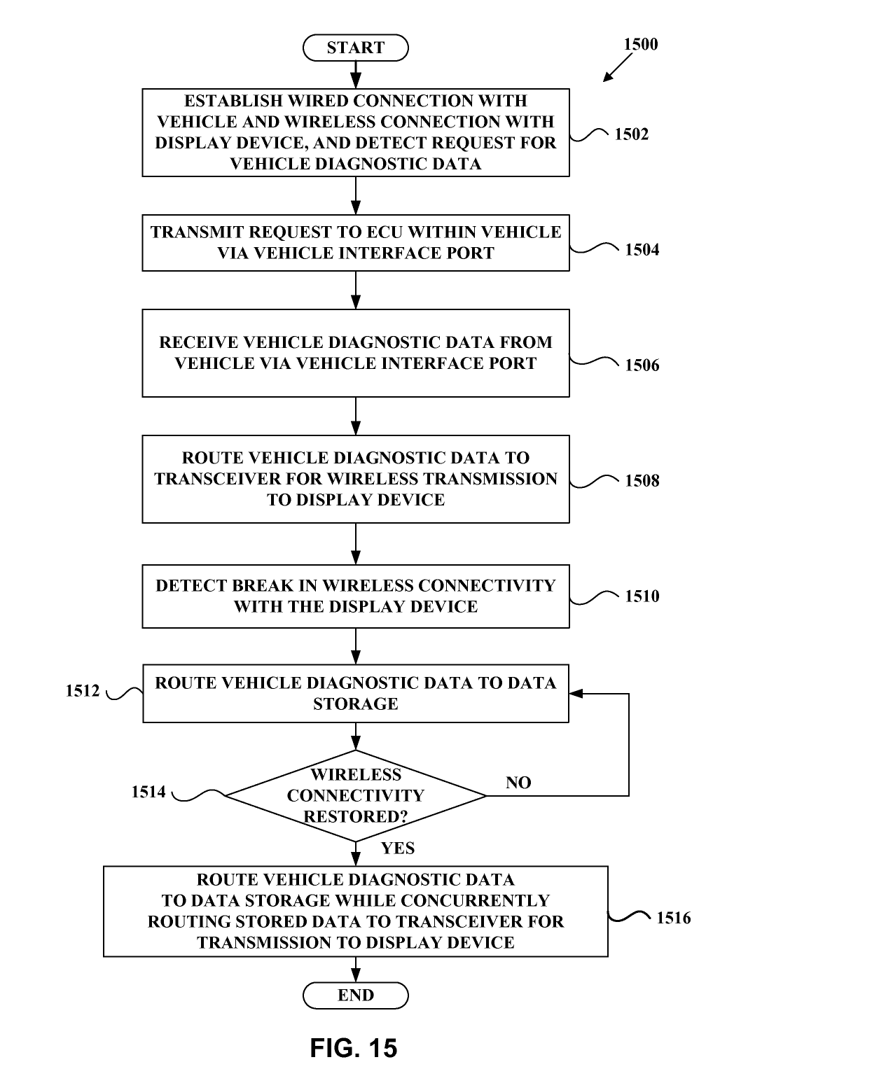

FIG. 15 is a flowchart illustrating an exemplary operation 1500 of vehicle scanner 106. FIG. 15 is exemplary in nature. Accordingly, although FIG. 15 illustrates a number of steps in a particular order, vehicle scanner 106 could execute a subset of the steps set forth in FIG. 15, additional steps not shown in FIG. 15, or the steps of FIG. 15 in an order different than that shown in FIG. 15. The set of functions 1500 may be carried out via a custom designed ASIC within vehicle scanner 106, or may be carried out by processor 404 executing CRPI 412 that, together, implement the functions of FIG. 15.

As set forth in step 1502, vehicle scanner 106 first establishes a wired connection with vehicle 102 and a wireless connection with display device 108. As part of establishing the wired connection with vehicle 102, a repair technician may connect vehicle scanner 106 via its vehicle connector port 800 to a vehicle diagnostic port on vehicle 102 via wired link 112. The exact placement of the vehicle diagnostic port (also called the “data link connector (DLC)”) within the vehicle 102 is variable, depending on the particular vehicle 102, its manufacturer, and the model of the vehicle 102 to which the vehicle scanner 106 is being connected.

In one embodiment, the wireless connection may be a BT connection, and establishing the wireless connection may include executing a pairing process with display device 108, or using previously stored pairing information to establish an active connection with display device 108. Of course, other types of wireless connections could additionally or alternatively be used, and BT is just an example.

As part of step 1502, vehicle scanner 106 may set its internal switches and circuits to match the interface required by vehicle 102. Switch and circuit settings may be stored locally in vehicle scanner data 414 (perhaps in a memory card inserted into memory card slot 1306) or may be transmitted to vehicle scanner 106 by an external device, such as display device 108. In the event that the switch and circuit settings are stored locally within the vehicle scanner 106, an external device such as display device 108 may still provide a make/model or other identifying information regarding the vehicle 102. The vehicle scanner 106 may then use the identifying information to index into the locally stored switch and circuit settings and implement the proper signaling standards required by the vehicle 102.

As a final part of step 1502, vehicle scanner 106 detects a request to retrieve vehicle diagnostic data from vehicle 102. Similar to the switch and circuit settings above, this request could be received from display device 108, or could be generated internally by, for example, CRPI loaded via the insertion or detection of a memory card in memory card slot 1306 containing a request for vehicle diagnostic data, and correspondingly executed by processor 404.

A request for vehicle diagnostic data in step 1502 may take the form of, for example, a request for the presence of any diagnostic trouble codes (DTCs), which are also known as error codes, from vehicle 102. Alternatively or additionally, the request could take the form of an inquiry regarding whether a particular DTC has been set. Furthermore, particular attributes may be requested to be interrogated or monitored. For example, requests may be generated relating to the engine, the anti-lock braking system (ABS), the transmission, the air bag controller and/or other systems or modules of vehicle 102. A request may seek information about an individual sensor, such as a throttle, revolutions per minute (RPM), or coolant temperature. Additionally, a request may cause a test to be initiated by the ECU in the vehicle 102 and resultant diagnostic information about the test returned to the vehicle scanner 106.

At step 1504, vehicle scanner 106 will transmit a corresponding request to the ECU within vehicle 102 via its vehicle interface port 800, link 112, and the vehicle diagnostic port on the vehicle 102. In response, at step 1506 the ECU in the vehicle 102 will perform the instructions and/or retrieve the information in the request, and responsively provide vehicle diagnostic data back to the vehicle scanner 106 via its vehicle interface port 800.

At step 1508, vehicle scanner 106 will begin receiving vehicle diagnostic data, and begin routing the data to wireless transceiver 402 for transmission to display device 108 via wireless communication link 118. As shown in FIG. 4, the data received from the vehicle interface port 800 may be routed via bus 410 to the wireless transceiver 402 for transmission to display device 108.

During this period of time, vehicle scanner 106 may be monitoring the condition of the wireless communication link 118 with the display device 108. As part of the wireless protocol, display device 108 may provide a periodic indication to vehicle scanner 106 that vehicle scanner 106 may use to confirm the status of the wireless communication link 118. This indication may be, for example, acknowledgement packets acknowledging receipt of vehicle diagnostic data transmitted by vehicle scanner 106 to display device 108. Alternatively, display device 108 may broadcast a pulse (or “heartbeat”) that vehicle scanner 106 may listen for to determine the status of the wireless communication link 118. Transferred commands and/or data itself may also provide an indication as to the status of the link 118.

At step 1510, vehicle scanner 106 detects a break in wireless connectivity with display device 108. The detection of a break in connectivity may be caused by a failure to receive an acknowledgment to one or more transmitted packets within a particular period of time. Alternatively, the detection of a break in wireless connectivity may be caused by a failure to detect a pulse or heartbeat from the display device 108. The detection may also be based on a failure to receive any data and/or commands from display device 108 for a period of time. Of course, other methods of detecting a break in wireless connectivity could also be implemented.

Once a break in wireless connectivity is detected at step 1512 vehicle scanner 106, at least temporarily, halts routing received vehicle diagnostic data from vehicle interface port 800 to wireless transceiver 402, and instead routes received vehicle diagnostic data from vehicle interface port 800 to data storage device 408, and more specifically, to vehicle diagnostic data store 416.

At the same or similar time, vehicle scanner 106 may provide an external indication of the break in wireless connectivity via its user interface 400. For example, processor 404 may cause visual indicator 504 to begin flashing with a particular pattern to indicate a detected break in wireless connectivity with display device 108. Of course, other types of visual indicators could alternatively be used, including, for example, a liquid crystal display (LCD) screen that may indicate the wireless connectivity error via a plain text statement displayed on the screen. Additionally or alternatively, an audio indicator of a break in wireless connectivity may be provided via an audio output device. Providing a visual and/or audio indicator may allow a repair technician to remedy the cause of the loss of wireless connectivity in short order. For example, a repair technician who has perhaps carried the display device 108 too far away from the vehicle scanner 106 may bring the display device 108 back closer to the vehicle scanner 106. Or, perhaps a repair technician who has started an activity, such as using a cordless telephone that interferes with the wireless communication link 118, may stop the interfering activity.

Vehicle scanner 106 will continue to buffer vehicle diagnostic data received at its vehicle interface port 800 to data storage 208 until wireless connectivity has been restored. As part of this process, vehicle scanner 106 will continue to monitor wireless connectivity with the display device 108 and attempt to re-establish the wireless communications link 118. At step 1514, vehicle scanner determines whether wireless connectivity with display device 108 has been restored. If wireless connectivity has not been restored, vehicle scanner will return to step 1512 and continue to buffer vehicle diagnostic data received at its vehicle interface port 800 to data storage 208. In the event that wireless connectivity with display device 108 experiences an extended period of disconnect, and storage space in vehicle diagnostic data store 416 begins approaching capacity, processor 404 may cause visual indicator 504 to flash with a different, perhaps more intense, visual pattern. Similarly, a different audio indicator may be emitted in this situation. If wireless connectivity can not be restored, a repair technician may be able to add more storage space as a temporary fix by inserting a memory card into memory card slot 1306 of vehicle scanner 106. Vehicle scanner 106 may then recognize the availability of additional storage space via memory card slot 1306 and begin routing vehicle diagnostic data received at its vehicle interface port 800 to the memory card in the memory card slot 1306 via bus 210.

Additionally or alternatively, a repair technician that is unable to resolve the wireless connectivity issues may instead provide a wired-line connection between the vehicle scanner 106 and display device 108 to complete the transfer of vehicle diagnostic data to display device 108. In the event that vehicle scanner 106 detects a valid connection with display device 108 via its wired interface 406, it may use a “first in, first out” strategy to begin routing vehicle diagnostic data previously stored in vehicle diagnostic data store 416 to wired interface 406 for transmission to display device 108 via a wired-line connection. The wired-line connection could be one or more of a USB connection via USB port 1304, an Ethernet connection via Ethernet ports 1300, 1302, or some other wired-line connection. During this time, additional vehicle diagnostic data received from vehicle 102 via vehicle interface port 800 will continue to be routed to vehicle diagnostic data store 416. In the event that vehicle diagnostic data can be read out from vehicle diagnostic data store 416 and transmitted to display device 108 at a faster pace than vehicle diagnostic data is being received from vehicle 102 via vehicle interface port 800, the vehicle diagnostic data store 416 may eventually be emptied of stored data.

After detecting that no more data exists in the vehicle diagnostic data store 416, vehicle scanner 106 may cause future vehicle diagnostic data received from vehicle 102 via vehicle interface port 800 to be routed directly to wired interface 406 for transmission to display device 108. Once vehicle 102 stops producing and sending data to vehicle scanner 106, or perhaps once vehicle scanner 106 is disconnected from the vehicle 102, any remaining vehicle diagnostic data can be read out from vehicle diagnostic data store 416 and transmitted to display device 108 via wired interface 406.

Responsive to vehicle scanner 106 detecting at step 1514 that wireless connectivity has been restored by, for example, again detecting a pulse or heartbeat from display device 108, vehicle scanner 106 proceeds to step 1516 and re-establishes the wireless communications link 118 with display device 108. After re-establishing wireless communications link 118, vehicle scanner 106 uses a “first in, first out” strategy to begin routing vehicle diagnostic data previously stored in vehicle diagnostic data store 416 to wireless transceiver 402 for transmission to display device 108. During this time, additional vehicle diagnostic data received from vehicle 102 via vehicle interface port 800 will continue to be routed to vehicle diagnostic data store 416. In the event that vehicle diagnostic data can be read out from vehicle diagnostic data store 416 and transmitted to display device 108 at a faster pace than vehicle diagnostic data is being received from vehicle 102 via vehicle interface port 800, the vehicle diagnostic data store 416 may eventually be emptied of stored data.

After detecting that no more data exists in the vehicle diagnostic data store 416, vehicle scanner 106 may cause future vehicle diagnostic data received from vehicle 102 via vehicle interface port 800 to be routed directly to wireless transceiver 402 for transmission to display device 108. Once vehicle 102 stops producing and sending data to vehicle scanner 106, or perhaps once vehicle scanner 106 is disconnected from the vehicle 102, any remaining vehicle diagnostic data can be read out from vehicle diagnostic data store 416 and transmitted to display device 108 via wireless transceiver 402.

Of course, once wireless connectivity is restored in step 1516, any prior audio or visual indicators of a problem with wireless connectivity may be halted. For example, a visual indication of an error in wireless connectivity at visual indicator 504 of vehicle scanner 106 may be halted.

In the unlikely event that wireless communications between vehicle scanner 106 and display device 108 can not be restored, any vehicle diagnostic data stored in the memory card in the memory card slot 1306 via bus 210 may be manually transferred to display device 108 via the memory card. This mechanism provides a fail-safe mechanism against prolonged problems with the wireless communications link 118 between vehicle scanner 106 and display device 108. Alternatively, vehicle scanner 106 may automatically, responsive to detecting an insertion of a memory card in memory card slot 1306, begin copying vehicle diagnostic data being temporarily buffered in a permanent internal storage portion of data storage device 408.

### III. Conclusion

Example embodiments of the present invention have been described above. Those skilled in the art will understand that changes and modifications may be made to the described embodiments without departing from the true scope and spirit of the present invention, which is defined by the claims.

We claim:

1. A vehicle diagnostic device capable of being connected to a diagnostic port of a vehicle, comprising:
a processor;
data storage;
a vehicle interface configured to interface with the diagnostic port of the vehicle, transmit commands to a vehicle diagnostic system via the diagnostic port, and receive diagnostic data from the vehicle diagnostic system via the diagnostic port; and
a wireless communications interface configured to transmit the diagnostic data to the one or more display devices;
wherein the processor is configured to:
monitor a status of the wireless interface;
cause vehicle diagnostic data received from the vehicle interface to be routed to the wireless communications interface for transmission to the one or more display devices; and
responsive to detecting a break in wireless connectivity with the one or more display devices, cause the vehicle diagnostic data being received from the vehicle interface to instead be routed to the data storage.

2. The vehicle diagnostic device of claim 1, wherein the processor is further configured to, responsive to detecting that wireless connectivity with the one or more display devices has been restored, begin routing the stored vehicle diagnostic data to the wireless interface for transmission to the one or more display devices.

3. The vehicle diagnostic device of claim 2, wherein the processor is further configured to continue causing vehicle diagnostic data received from the vehicle interface to be stored in the data storage while simultaneously routing the stored vehicle diagnostic data to the wireless communications interface for transmission to the one or more display devices.

4. The vehicle diagnostic device of claim 1, wherein the processor is configured to, responsive to detecting the break in wireless connectivity with the one or more display devices, cause an external indication of the break in wireless connectivity to be made.

5. The vehicle diagnostic device of claim 4, wherein the external indication is a lighted visual indicator.

6. The vehicle diagnostic device of claim 4, wherein the external indication is an audio tone.

7. The vehicle diagnostic device of claim 1, further comprising:
a wire-line communications interface;
wherein the processor is further configured to, responsive to detecting an available connection to the one or more display devices via the wire-line communications interface, begin routing the stored vehicle diagnostic data to the wire-line communications interface for transmission to the one or more display devices.

8. The vehicle diagnostic device of claim 7, wherein the wire-line communications interface is one selected from the group consisting of universal serial bus (USB) and Ethernet.

9. The vehicle diagnostic device of claim 8, wherein the processor is further configured to continue causing vehicle diagnostic data received from the vehicle interface to be stored in the data storage while simultaneously routing the stored vehicle diagnostic data to the wire-line interface for transmission to the one or more display devices.

10. The vehicle diagnostic device of claim 1, wherein the data storage comprises a removable memory storage device.

11. A method of processing vehicle diagnostic data comprising:
a diagnostic device receiving vehicle diagnostic data via a vehicle interface with a diagnostic port of a vehicle;
the diagnostic device monitoring a status of a wireless communications interface for transmitting the vehicle diagnostic data to one or more display devices;
responsive to detecting a break in wireless connectivity with the one or more display devices via the wireless communications interface, the diagnostic device stopping routing of the vehicle diagnostic data from the vehicle interface to the wireless interface and instead beginning routing of the vehicle diagnostic data to a local storage.

12. The method of claim 11, further comprising, responsive to detecting that wireless connectivity with the one or more display devices has been restored, the diagnostic device beginning routing the stored vehicle diagnostic data to the wireless communications interface for transmission to the one or more display devices.

13. The method of claim 12, further comprising the diagnostic device continuing to route the vehicle diagnostic data received from the vehicle interface to the local storage device while simultaneously routing the stored vehicle diagnostic data from the local storage to the wireless communications interface for transmission to the one or more display devices.

14. The method of claim 11, further comprising, responsive to detecting the break in wireless connectivity with the one or more display devices, the diagnostic device causing an external indication of the break in wireless connectivity to be made.

15. The method of claim 14, wherein the external indication is a lighted visual indicator.

16. The method of claim 14, wherein the external indication is an audio tone.

17. The method of claim 11, further comprising, responsive to detecting an available connection to the one or more display devices via a wire-line communications interface, the diagnostic device routing the stored vehicle diagnostic data to the wire-line communications interface for transmission to the one or more display devices.

18. The method of claim 17, wherein the wire-line communications interface is one selected from the group consisting of universal serial bus (USB) and Ethernet.

19. The method of claim 17, further comprising the diagnostic device continuing to route the vehicle diagnostic data received from the vehicle interface to the local storage device while simultaneously routing the stored vehicle diagnostic data from the local storage to the wire-line communications interface for transmission to the one or more display devices.

20. The method of claim 19, wherein the data storage comprises a removable memory storage device.
